(19) United States
(12) Patent Application Publication
(10) Pub. No.: US 2007/0135323 A1
(43) Pub. Date: Jun. 14, 2007

(54) Use of metal complex compounds as oxidation catalysts

(75) Inventors: Ralf Wiedemann, Ludwigshafen (DE); Frank Bachmann, Freiburg (DE); Joseph Dannacher, Basel (CH); Marie-Josee Dubs, Wittersdorf (FR); Menno Hazenkamp, Riehen (CH); Grit Richter, Neuenburg (DE); Gunther Schlingloff, Riehen (CH); Brigitte Schmidt, Lorrach (DE); Albert Schneider, Weil am Rhein (DE); Peter Wiengartner, Diegten (CH); Torsten Wieprecht, Maulberg (DE)

Correspondence Address: NORRIS, MCLAUGHLIN & MARCUS, 875 THIRD AVE, 18TH FLOOR, NEW YORK, NY, 10022, US

(73) Assignee: Reckitt Benckiser N.V., Hooffdorp (NL)

(21) Appl. No.: 10/533,031

(22) PCT Filed: Oct. 28, 2003
(86) PCT No.: PCT/GB03/04625

§ 371 Date: Dec. 13, 2005

(30) Foreign Application Priority Data
Oct. 30, 2002 (GB) 0225240.1

(51) Int. Cl. C11D 3/39

(52) U.S. Cl. 510/220; 510/499

(57) ABSTRACT

An automatic dishwasher detergent formulation comprising:—(a) a metal complex compounds of formula (1)[LₙMeₘ,Xₚ] ^{z}Y_{q} wherein Me is manganese, titanium, iron, cobalt, nickel or copper, X is a coordinating or bridging radical, n and m are each independently of the other an integer having a value of from 1 to 8, p is an integer having a value of from 0 to 32, z is the charge of the metal complex, Y is a counter-ion, q=z/(charge Y), and L is a ligand of formula (2); wherein R₁, R₂, R₃, R₄, R₅, R₆, R₇, R₈, R₉, R₁₀ and R₁₁ are each independently of the others hydrogen; unsubstituted or substituted C₁-C₁₈alkyl or aryl; cyano; halogen; nitro; —COOR₁₂ or —SO₃R₁₂ wherein R₁₂ is in each case hydrogen, a cation or unsubstituted or substituted C₁-C₁₈alkyl or aryl; SR₁₃, —SO₂R₁₃ or −OR₁₃ wherein R₁₃ is in each case hydrogen or unsubstituted or substituted C₁-C₁₈alkyl or aryl; —N(R₁₃)—NR′₁₃R″₁₃ wherein R₁₃, R′13 and R″₁₃ are as defined above for R₁₃; —NR₁₄NR₁₅ or —N^{⊕}R₁₄R₁₅R₁₆ wherein R₁₄, R₁₅ and R₁₆ are each independently of the other(s) hydrogen or unsubstituted or substituted C₁-C₁₈alkyl or aryl, or R₁₄ and R₁₅ together with the nitrogen atom bonding them from an unsubstituted or substituted 5-, 6- or 7-membered ring which may optionally contain further hetero atoms; with the proviso that R₁, R₂, R₃, R₄, R₅, R₆, R₇, R₈, R₉, R₁₀ and R₁₁ are not simultaneously hydrogen, as a catalyst for oxidation reactions; and (b) an enzyme.

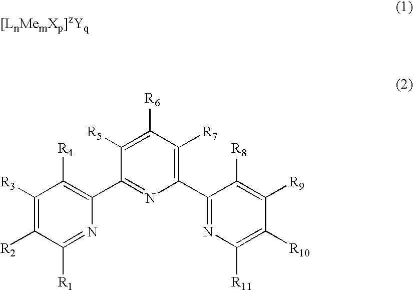

The present invention relates to the use of metal complex compounds with terpyridine ligands as oxidation catalysts in dishwasher detergent formulations.

Peroxide-containing bleaching agents have been used in washing and cleaning processes for some time. Such agents are particularly useful in dishwasher applications to aid the removal of foodstuff residues and stains produced on crockery and other kitchenware in cooking processes. Their action is particularly important on coloured stains such as those produced by tomato based foodstuffs and tea.

Peroxide-containing bleaching agents have been found to perform well at a liquor temperature of 90° C. and above, but their performance noticeably decreases with lower temperatures. Thus when crockery and other kitchenware is washed in a dishwasher at lower temperatures, there can be a problem of incomplete stain removal. This is unpleasant from an aesthetic point of view and also can present detrimental hygiene issues.

It is known that various transition metal ions, added in the form of suitable salts, or co-ordination compounds containing such cations catalyse the decomposition of H₂O₂. In that way it is possible to increase the bleaching action of H₂O₂, or of precursors that release H₂O₂, or of other peroxo compounds, the bleaching action of which is unsatisfactory at lower temperatures. Particularly significant in the dishwasher context are those combinations of transition metal ions and ligands the peroxide activation of which is manifested in an increased tendency towards oxidation in respect of substrates (stains and foodstuffs) and not only in a catalase-like disproportionation. The latter activation, which tends rather to be undesirable in the present case, could impair the bleaching effects of H₂O₂ and its derivatives which are insufficient at low temperatures.

In respect of H₂O₂ activation having effective bleaching action, mononuclear and polynuclear variants of manganese complexes with various ligands, especially with 1,4,7-trimethyl-1,4,7-triazacyclononane and optionally oxygen-containing bridge ligands, are currently regarded as being especially effective. Such catalysts have adequate stability under practical conditions and, with Mnⁿ⁺, contain an ecologically acceptable metal cation, but their use is unfortunately associated with high cost implications.

The aim of the present invention was, therefore, to provide improved metal complex catalysts for oxidation processes which fulfil the above demands and, especially, improve the action of peroxy compounds in a dishwashing environment without giving rise to any appreciable damage of the items being cleaned or the dishwasher itself.

The invention accordingly relates to an automatic dishwasher detergent formulation comprising:—

(a) a metal complex compounds of formula (1)
[LₙMeₘXₚ]^{z}Y_{q} (1)

wherein Me is manganese, titanium, iron, cobalt, nickel or copper,

X is a co-ordinating or bridging radical,

n and m are each independently of the other an integer having

a value of from 1 to 8,

p is an integer having a value of from 0 to 32,

z is the charge of the metal complex,

Y is a counter-ion,

q=z/(charge Y), and

L is a ligand of formula

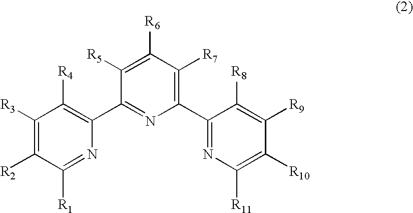

wherein

R₁, R₂, R₃, R₄, R₅, R₆, R₇, R₈, R₉, R₁₀ and R₁₁ are each independently of the others hydrogen; unsubstituted or substituted C₁-C₁₈alkyl or aryl; cyano; halogen; nitro; —COOR₁₂ or —SO₃R₁₂ wherein R₁₂ is in each case hydrogen, a cation or unsubstituted or substituted C₁-C₁₈alkyl or aryl; —SR₁₃, —SO₂R₁₃ or —OR₁₃ wherein R₁₃ is in each case hydrogen or unsubstituted or substituted C₁-C₁₈alkyl or aryl; —N(R₁₃)—NR′₁₃R″₁₃ wherein R₁₃, R′₁₃ and R″₁₃ are as defined above for R₁₃; —NR₁₄R₁₅ or —N^{⊕}R₁₄R₁₅R₁₆ wherein R₁₄, R₁₅ and R₁₆ are each independently of the other(s) hydrogen or unsubstituted or substituted C₁-C₁₈alkyl or aryl, or R₁₄ and R₁₅ together with the nitrogen atom bonding them form an unsubstituted or substituted 5-, 6- or 7-membered ring which may optionally contain further hetero atoms; with the proviso that R₁, R₂, R₃, R₄, R₅, R₆, R₇, R₈, R₉, R₁₀ and R₁₁ are not simultaneously hydrogen, as catalysts for oxidation reactions; and

(b) an enzyme.

The mentioned C₁-C₁₈alkyl radicals are generally, for example, straight-chain or branched alkyl radicals, such as methyl, ethyl, n-propyl, isopropyl, n-butyl, sec-butyl, isobutyl, tert-butyl or straight-chain or branched pentyl, hexyl, heptyl or octyl. Preference is given to C₁-C₁₂alkyl radicals, especially C₁-C₈alkyl radicals and more especially C₁-C₄alkyl radicals. The mentioned alkyl radicals can be unsubstituted or substituted e.g. by hydroxyl, C₁-C₄alkoxy, sulfo or by sulfato, especially by hydroxyl. The corresponding unsubstituted alkyl radicals are preferred. Very special preference is given to methyl and ethyl, especially methyl.

Examples of aryl radicals that generally come into consideration are phenyl or naphthyl unsubstituted or substituted by C₁-C₄alkyl, C₁-C₄alkoxy, halogen, cyano, nitro, carboxyl, sulfo, hydroxyl, amino, N-mono- or N,N-di-C₁-C₄alkylamino unsubstituted or substituted by hydroxy in the alkyl moiety, N-phenylamino, N-naphthylamino, phenyl, phenoxy or by naphthoxy. Preferred substituents are C₁-C₄alkyl, C₁-C₄alkoxy, phenyl and hydroxy. Special preference is given to the corresponding phenyl radicals.

Halogen is generally especially chlorine, bromine or fluorine, special preference being given to chlorine.

Examples of cations that generally come into consideration are alkali metal cations, such as lithium, potassium and especially sodium, alkaline earth metal cations, such as magnesium and calcium, and ammonium cations. The corresponding alkali metal cations, especially sodium, are preferred.

Suitable metal ions for Me are e.g. manganese in oxidation states II-V, titanium in oxidation states III and IV, iron in oxidation states I to IV, cobalt in oxidation states I to III, nickel in oxidation states I to III and copper in oxidation states I to III, with special preference being given to manganese, especially manganese in oxidation states II to IV, preferably in oxidation state II. Also of interest are titanium IV, iron II-IV, cobalt II-III, nickel II-III and copper II-III, especially iron II-IV.

For the radical X there come into consideration, for example, CH₃CN, H₂O, F⁻, Cl⁻, Br⁻, HOO⁻, O₂²⁻, O²⁻, R₁₇COO⁻, R₁₇O⁻, LMeO⁻ and LMeOO⁻, wherein R₁₇ is hydrogen or unsubstituted or substituted C₁-C₁₈alkyl or aryl, and C₁-C₁₋₈alkyl, aryl, L and Me have the definitions and preferred meanings given hereinabove and hereinbelow. R₁₇ is especially hydrogen, C₁-C₄alkyl or phenyl, more especially hydrogen.

As counter-ion Y there come into consideration, for example, R₁₇COO⁻, ClO₄⁻, BF₄⁻, PF₆⁻, R₁₇SO₃⁻, R₁₇SO₄⁻, SO₄²⁻, NO₃⁻, F⁻, Cl⁻, Br⁻ and I⁻, wherein R₁₇ is hydrogen or unsubstituted or substituted C₁-C₁₈alkyl or aryl. R₁₇ as C₁-C₁₈alkyl or aryl has the definitions and preferred meanings given hereinabove and hereinbelow. R₁₇ is especially hydrogen, C₁-C₄alkyl or phenyl, more especially hydrogen. The charge of the counter-ion Y is accordingly preferably 1− or 2−, especially 1−.

n is preferably an integer having a value of from 1 to 4, preferably 1 or 2 and especially 1.

m is preferably an integer having a value of 1 or 2, especially 1.

p is preferably an integer having a value of from 0 to 4, especially 2.

z is preferably an integer having a value of from 8− to 8+, especially from 4− to 4+ and more especially from 0 to 4+. z is more especially the number 0.

q is preferably an integer from 0 to 8, especially from 0 to 4 and is more especially the number 0.

R₁₂ is preferably hydrogen, a cation, C₁-C₁₂alkyl, or phenyl unsubstituted or substituted as indicated above. R₁₂ is especially hydrogen, an alkali metal cation, alkaline earth metal cation or ammonium cation, C₁-C₄alkyl or phenyl, more especially hydrogen or an alkali metal cation, alkaline earth metal cation or ammonium cation.

R₁₃, R′₁₃ and R″₁₃ are preferably hydrogen, C₁-C₁₂alkyl, or phenyl unsubstituted or substituted as indicated above. R₁₃, R′₁₃ and R″₁₃ are especially hydrogen, C₁-C₄alkyl or phenyl, more especially hydrogen or C₁-C₄alkyl, preferably hydrogen. Examples of the radical of the formula —N(R₁₃)—NR′₁₃R″₁₃ that may be mentioned include —N(CH₃)—NH₂ and especially —NH—NH₂. Examples of the radical of the formula —OR₁₃ that may be mentioned include hydroxyl and C₁-C₄alkoxy, such as methoxy and especially ethoxy.

When R₁₄ and R₁₅ together with the nitrogen atom bonding them form a 5-, 6- or 7-membered ring it is preferably an unsubstituted or C₁-C₄alkyl-substituted pyrrolidine, piperidine, piperazine, morpholine or azepane ring. The piperazine ring can be substituted by C₁-C₄alkyl e.g. at the nitrogen atom not bonded to the phenyl radical. In addition, R₁₄, R₁₅ and R₁₆ are preferably hydrogen, unsubstituted or hydroxyl-substituted C₁-C₁₂alkyl, or phenyl unsubstituted or substituted as indicated above. Special preference is given to hydrogen, unsubstituted or hydroxyl-substituted C₁-C₄alkyl or phenyl, especially hydrogen or unsubstituted or hydroxyl-substituted C₁-C₄alkyl, preferably hydrogen. Examples of the radical of formula —NR₁₄R₁₅ that may be mentioned include —NH₂, —NHCH₂CH₂OH, —N(CH₂CH₂OH)₂, —N(CH₃)CH₂CH₂OH, and the pyrrolidine, piperidine, piperazine, morpholine or azepane ring and also 4-methyl-piperazin-1-yl.

Preference is given to ligands of formula (2) wherein R₆ is not hydrogen.

R₆ is preferably C₁-C₁₂alkyl; phenyl unsubstituted or substituted by C₁-C₄alkyl, C₁-C₄alkoxy, halogen, cyano, nitro, carboxyl, sulfo, hydroxyl, amino, N-mono- or N,N-di-C₁-C₄alkylamino unsubstituted or substituted by hydroxy in the alkyl moiety, N-phenylamino, N-naphthylamino, phenyl, phenoxy or by naphthoxy; cyano; halogen; nitro; —COOR₁₂ or —SO₃R₁₂ wherein R₁₂ is in each case hydrogen, a cation, C₁-C₁₂alkyl, or phenyl unsubstituted or substituted as indicated above; —SR₁₃, —SO₂R₁₃ or —OR₁₃ wherein R₁₃ is in each case hydrogen, C₁-C₁₂alkyl, or phenyl unsubstituted or substituted as indicated above; —N(R₁₃)—NR′₁₃R″₁₃ wherein R₁₃, R′₁₃ and R″₁₃ are as defined above for R₁₃; —NR₁₄R₁₅ or —N^{⊕}R₁₄R₁₅R₁₆ wherein R₁₄, R₁₅ and R₁₆ are each independently of the other(s) hydrogen, unsubstituted or hydroxyl-substituted C₁-C₁₂alkyl, or phenyl unsubstituted or substituted as indicated above, or R₁₄ and R₁₅ together with the nitrogen atom bonding them form an unsubstituted or C₁-C₄alkyl-substituted pyrrolidine, piperidine, piperazine, morpholine or azepane ring.

R₆ is especially phenyl unsubstituted or substituted by C₁-C₄alkyl, C₁-C₄alkoxy, halogen, phenyl or by hydroxyl; cyano; nitro; —COOR₁₂ or —SO₃R₁₂ wherein R₁₂ is in each case hydrogen, a cation, C₁-C₄alkyl or phenyl; —SR₁₃, —SO₂R₁₃ or —OR₁₃ wherein R₁₃ is in each case hydrogen, C₁-C₄alkyl or phenyl; —N(CH₃)—NH₂ or —NH—NH₂; amino; N-mono- or N,N-di-C₁-C₄alkylamino unsubstituted or substituted by hydroxy in the alkyl moiety; or an unsubstituted or C₁-C₄alkyl-substituted pyrrolidine, piperidine, piperazine, morpholine or azepane ring.

R₆ is very especially C₁-C₄alkoxy; hydroxy; phenyl unsubstituted or substituted by C₁-C₄alkyl, C₁-C₄alkoxy, phenyl or by hydroxy; hydrazino; amino; N-mono- or N,N-di-C₁-C₄alkylamino unsubstituted or substituted by hydroxy in the alkyl moiety; or an unsubstituted or C₁-C₄alkyl-substituted pyrrolidine, piperidine, piperazine, morpholine or azepane ring.

Especially important as radicals R₆ are C₁-C₄alkoxy; hydroxy; hydrazino; amino; N-mono- or N,N-di-C₁-C₄alkylamino unsubstituted or substituted by hydroxy in the alkyl moiety; or the unsubstituted or C₁-C₄alkyl-substituted pyrrolidine, piperidine, piperazine, morpholine or azepane ring.

Very especially important as radicals R₆ are C₁-C₄alkoxy; hydroxy; N-mono- or N,N-di-C₁-C₄alkylamino substituted by hydroxy in the alkyl moiety; or the unsubstituted or C₁-C₄alkyl-substituted pyrrolidine, piperidine, piperazine, morpholine or azepane ring, hydroxyl being of particular interest.

In this regard highly preferred compounds of formula (1) are shown below.

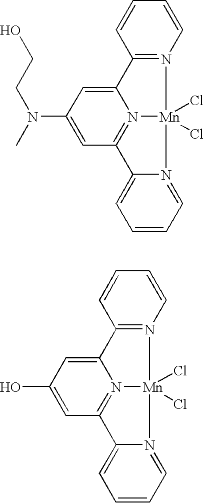

The preferred meanings indicated above for R₆ apply also to R₁, R₂, R₃, R₄, R₅, R₇, R₈, R₉, R₁₀ and R₁₁, but those radicals may additionally denote hydrogen.

In accordance with one embodiment of the present invention, R₁, R₂, R₃, R₄, R₅, R₇, R₈, R₉, R₁₀ and R₁₁ are hydrogen and R₆ is a radical other than hydrogen having the definitions and preferred meanings indicated above.

In accordance with a further embodiment of the present invention, R₁, R₂, R₄, R₅, R₇, R₈, R₁₀ and R₁₁ are hydrogen and R₃, R₆ and R₉ are radicals other than hydrogen having the definitions and preferred meanings indicated above for R₆.

Preferred ligands L are those of formula

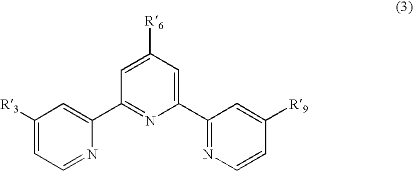

wherein R′₃ and R′₉ have the definitions and preferred meanings indicated above for R₃ and R₉, and R′₆ has the definitions and preferred meanings indicated above for R₆.

R′₃, R′₆ and R′₉ are preferably each independently of the others C₁-C₄alkoxy; hydroxy; phenyl unsubstituted or substituted by C₁-C₄alkyl, C₁-C₄alkoxy, phenyl or by hydroxy; hydrazino; amino; N-mono- or N,N-di-C₁-C₄alkylamino unsubstituted or substituted by hydroxy in the alkyl moiety; or an unsubstituted or C₁-C₄alkyl-substituted pyrrolidine, piperidine, piperazine, morpholine or azepane ring.

The metal complex compounds of formula (1) are known or can be obtained analogously to known processes. They are obtained in a manner known per se by reacting at least one ligand of formula (2) in the desired molar ratio with a metal compound, especially a metal salt, such as the chloride, to form the corresponding metal complex. The reaction is carried out, for example, in a solvent, such as water or a lower alcohol, such as ethanol, at a temperature of e.g. from 10 to 60° C., especially at room temperature.

Ligands of formula (2) that are substituted by hydroxyl can also be formulated as compounds having a pyridone structure in accordance with the following scheme (illustrated here using the example of a terpyridine substituted by hydroxyl in the 4′-position):

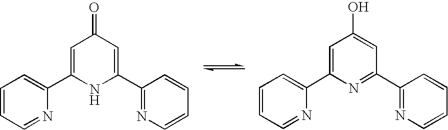

### terpyridin-4′-one structure terpyridin-4′-ol structure

Their special place within the terpyridine family results from the fact that such ligands are capable of being deprotonated and are therefore able to act as anionic ligands.

Generally, therefore, hydroxyl-substituted terpyridines are also to be understood as including those having a corresponding pyridone structure.

The ligands of formula (2) are known or can be prepared in a manner known per se. For that purpose, for example, two parts of pyridine-2-carboxylic acid ester and one part of acetone can be reacted with sodium hydride and the intermediate, a 1,3,5-triketone, obtained after aqueous working-up can be reacted with ammonium acetate to synthesise the central pyridine ring. The corresponding pyridone derivatives are obtained, which can be converted into the chlorine compounds by reaction with a chlorinating agent, such as PCl₅/POCl₃. Reactions of such compounds with amines, if desired in the presence of an excess of redox-active transition metal salts, such as iron or ruthenium, in order to accelerate the substitution, yield amine-substituted terpyridines. Such preparation processes are described, for example, in J. Chem. Soc., Dalton Trans. 1990, 1405-1409 (E. C. Constable et al.) and New. J. Chem. 1992, 16, 855-867.

It has now been found that for the accelerated substitution of halide by amine at the terpyridine structure it is also possible to use catalytic amounts of non-transition metal salts, such as zinc(II) salts, which considerably simplifies the reaction procedure and working-up.

Surprisingly, the formulation comprising metal complex compounds of formula (1) exhibits a markedly improved bleach-catalysing action on coloured stains on hard surfaces. Their efficacy is exceptionally evident in the removal of food stains from hard surfaces in automatic dishwashing. Indeed the addition of such complexes in catalytic amounts to a dishwashing agent that comprises a peroxy compound and optionally a further bleach activator (such as, for example, TAED (N,N,N′,N′-tetraacetylethylenediamine)) results in the substantial removal of e.g. tea stains on china. This is the case even when hard water is used, it being known that tea deposits are more difficult to remove in hard water than in soft water.

Formulations comprising the metal complex compounds of formula (1) also have, together with peroxy compounds, excellent antibacterial action. The use of the metal complex compounds of formula (1) for killing bacteria or for protecting against bacterial attack is therefore likewise of interest, especially in the field of automatic dishwashing where it is particularly important that the cleaned items, following a dishwashing operation, should be largely free of bacteria.

The enzyme is preferably selected from the group consisting of cellulases, hemicellulases, peroxidases, proteases, gluco-amylases, amylases, xylanases, lipases, phospholipases, esterases, cutinases, pectinases, keratanases, reductases, oxidases, phenoloxidases, lipoxygenases, ligninases, pullulanases, tannases, pentosanases, malanases, beta.-glucanases, arabinosidases, hyaluronidase, chondroitinase, laccase or mixtures thereof.

The enzyme is most preferably a protease.

One suitable protease has maximum activity throughout the pH range of 8-12, and is sold as ESPERASE® by Novo Industries A/S of Denmark. Other suitable proteases include ALCALASE®, DURAZYM® and SAVINASE®also from Novo Indutries and MAXATASE®, MAXACAL®, PROPERASE® and MAXAPEM® (protein engineered Maxacal) from Gist-Brocades. Further suitable proteases include PURAFECT® (available from Genencor); also EVERLASE® and OVOZYM® (available from Novozymes); and KEMZYM® (available from Biozym).

Suitable proteolytic enzymes also include modified bacterial serine proteases. Other suitable proteases include subtilisins which are obtained from B. subtilis and B. licheniformis.

Preferred proteases include carbonyl hydrolase variants having an amino acid sequence not found in nature, which are derived from a precursor carbonyl hydrolase by substituting a different amino acid for a plurality of amino acid residues.

The protease enzyme is preferably incorporated in the formulation of the present invention a level of from 0.0001% to 2% pure enzyme by weight of the formulation.

Amylases (alpha and/or beta) can be included in the formulation for removal of carbohydrate-based stains. Other suitable amylases are stability-enhanced amylases.

Examples of commercial alpha-amylases products are Purastar® and Purafect Ox Am® from Genencor. Further suitable commercially available alpha-amylases include Termamyl®, Ban®, Fungamyl® and Duramyl®, all available from Novo Nordisk A/S Denmark. Termamyl® is an alpha-amylases characterised by having a specific activity at least 25% higher than the specific activity of at a temperature range of 25. degree. C. to 55. degree. C. and at a pH value in the range of 8 to 10, measured by the Phadebas® alpha-amylase activity assay.

The amylolytic enzyme is preferably incorporated in the detergent compositions of the present invention a level of from 0.0001% to 2% pure enzyme by weight of the formulation.

The above-mentioned enzymes may be of any suitable origin, such as vegetable, animal, bacterial, fungal and yeast origin. Origin can further be mesophilic or extremophilic (psychrophilic, psychrotrophic, thermophilic, barophilic, alkalophilic, acidophilic, halophilic, etc.). Purified or non-purified forms of these enzymes may be used. Also included by definition, are mutants of native enzymes. Mutants can be obtained e.g. by protein and/or genetic engineering, chemical and/or physical modifications of native enzymes.

As enzymes can react detrimentally with other components of detergent formulations the enzyme may be separated from the remainder of the formulation. Separation is of particular consideration with regard to oxygen sources and oxidising agents, such as bleaches, which are known to cause deterioration of enzymes. The separation may be achieved by physical separation of the formulation into at least two components; such as by the use of a twin chamber bottle, a twin layer tablet or a twin compartment pouch; wherein the enzyme is separated from antagonistic components. An alternative means of separation is by encapsulation. The method of encapsulation and the material used for encapsulation may vary dependent on the physical nature of the formulation. For example in a liquid formulation an encapsulation agent such as wax may be used. Whereas in a solid formation a more rigid encapsulation material, such as a saccharide optionally in combination with a pigment such as titanium dioxide, may be used.

The dishwashing process is usually carried out by using an aqueous liquor comprising a peroxide and an amount of dishwasher detergent formulation such that from 0.1 to 200 mg of one or more compounds of formula (1) is/are present per litre of liquor. The dishwashing liquor more preferably contains from 1 to 75, more preferably from 3 to 50 and most preferably from 3 to 30 mg of the compound of formula (1) per litre of liquor. It will be understood that in such an application, the metal complex compounds of formula (1) can alternatively be formed in situ, the metal salt (e.g. manganese(II) salt, such as manganese(II) chloride) and the ligand being added in the desired molar ratios.

As the peroxide component there come into consideration, for example, the organic and inorganic peroxides known in the literature and available commercially that provide a bleach function at conventional dishwashing temperatures, for example at from 10 to 95° C. Preferably the formulation contains such a peroxide component.

The organic peroxides are, for example, mono- or poly-peroxides, especially organic peracids or salts thereof, such as phthalimidoperoxycaproic acid, peroxybenzoic acid, diperoxydodecanedioic acid, diperoxynonanedioic acid, diperoxydecanedioic acid, diperoxyphthalic acid or salts thereof.

Preferably, however, inorganic peroxides are used, for example persulfates, perborates, percarbonates and/or persilicates.

Percarbonate and perborate are particularly preferred. Also hydrogen peroxide may be incorporated into the formulation. In this case it will be appreciated that a stabiliser and/or a thickener may be required to provide, for example, adequate stability (i.e. shelf-life) of the hydrogen peroxide. Also where hydrogen peroxide is used, for stability reasons, it may be separated from the rest of the formulation in a separate portion. Methods of separation may be similar to those discussed above in connection with enzymes.

It will be understood that mixtures of inorganic and/or organic peroxides can also be used. The peroxides may be in a variety of crystalline forms and have different water contents, and they may also be used together with other inorganic or organic compounds in order to improve their storage stability.

The formulation may contain a surfactant. Preferably the surfactant is present in an amount of up to 30 wt % of the formulation and more preferably up to 10 wt % of the formulation.

Suitable surfactants are selected from anionic, cationic, ampholytic and zwitterionic surfactants and mixtures thereof. As the formulation is for use in automatic dishwashing the surfactant is preferably low foaming in character. To achieve this aim the surfactant system for use in dishwashing methods may be suppressed.

Nonionic surfactants are preferred for incorporation into the formulation as they are recognised to provide a suds suppression benefit. The alkyl ethoxylate condensation products of an alcohol with from 1 to 80 moles of an alkylene (liner/branched aliphatic/aromatic optionally subsituted C₂ to C₂₀ alkylene) oxide are suitable for this use. The alkyl chain of the alcohol can either be straight or branched, primary or secondary, and generally contains from 6 to 22 carbon atoms. Particularly preferred are the condensation products of alcohols having an alkyl group containing from 8 to 20 carbon atoms with from 2 to 10 moles of ethylene oxide per mole of alcohol. In this regard Suitable surfactants include POLY-TERGENT® SLF-18B nonionic surfactants by Olin Corporation.

Ethoxylated C₆-C₁₈ fatty alcohols and C₆-C₁₈ mixed ethoxylated/propoxylated fatty alcohols are suitable surfactants for use herein. Preferably the ethoxylated fatty alcohols are the C₁₀-C₁₈ ethoxylated fatty alcohols with a degree of ethoxylation of from 3 to 50, most preferably these are the C₁₂-C₁₈ ethoxylated fatty alcohols with a degree of ethoxylation from 3 to 40. Preferably the mixed ethoxylated/propoxylated fatty alcohols have an alkyl chain length of from 10 to 18 carbon atoms, a degree of ethoxylation of from 3 to 30 and a degree of propoxylation of from 1 to 10.

The condensation products of ethylene oxide with a hydrophobic base formed by the condensation of propylene oxide with propylene glycol are suitable for use herein. The hydrophobic portion of these compounds preferably has a molecular weight of from 1500 to 1800 and exhibits water insolubility. Examples of compounds of this type include certain of the commercially-available Pluronic™ surfactants, marketed by BASF.

The condensation products of ethylene oxide with the product resulting from the reaction of propylene oxide and ethylenediamine are suitable for use herein. The hydrophobic moiety of these products consists of the reaction product of ethylenediamine and excess propylene oxide, and generally has a molecular weight of from 2500 to 3000. Examples of this type of nonionic surfactant include certain of the commercially available Tetronic™ compounds, marketed by BASF.

In a preferred embodiment of the present invention the formulation comprises a mixed nonionic surfactant system.

The formulation may contain a builder/co-builder. Preferably the builder and/or co-builder is present in an amount of up to 90 wt % of the formulation and more preferably up to 70 wt % of the formulation.

By co-builder it is meant a compound which acts in addition to a builder compound to sequester (chelate) heavy metal ions. These components may also have calcium and magnesium chelation capacity, but preferentially they show selectivity to binding heavy metal ions such as iron, manganese and copper. Co-builders, which are typically acidic, having for example phosphonic acid or carboxylic acid functionalities, may be present either in their acid form or as a complex/salt with a suitable counter cation such as an alkali or alkaline metal ion, ammonium, or substituted ammonium ion, or any mixtures thereof. The molar ratio of said counter cation to the co-builder is preferably at least 1:1. Suitable co-builders for use herein include organic phosphonates, such as the amino alkylene poly(alkylene phosphonates), alkali metal ethane 1-hydroxy disphosphonates and nitrilo trimethylene phosphonates. Preferred among the above species are diethylene triamine penta(methylene phosphonate), ethylene diamine tri(methylene phosphonate)hexamethylene diamine tetra(methylene phosphonate) and hydroxy-ethylene 1,1 diphosphonate. Other suitable co-builders for use herein include nitrilotriacetic acid and polyaminocarboxylic acids such as ethylenediaminotetracetic acid, ethylenetriamine pentacetic acid, ethylenediamine disuccinic acid, ethylenediamine diglutaric acid, 2-hydroxypropylenediamine disuccinic acid or any salts thereof. Especially preferred is ethylenediamine-N,N′-disuccinic acid (EDDS) or the alkali metal, alkaline earth metal, ammonium, or substituted ammonium salts thereof, or mixtures thereof. Preferred EDDS compounds are the free acid form and the sodium or magnesium salt or complex thereof.

Suitable water-soluble builder compounds include the water soluble carboxylates or their acid forms, homo or copolymeric polycarboxylic acids or their salts in which the polycarboxylic acid comprises at least two carboxylic radicals separated from each other by not more than two carbon atoms, carbonates, bicarbonates, borates, phosphates, and mixtures of any of the foregoing. The carboxylate or polycarboxylate builder can be monomeric or oligomeric in type although monomeric polycarboxylates are generally preferred for reasons of cost and performance. Suitable carboxylates containing one carboxy group include the water soluble salts of lactic acid, glycolic acid and ether derivatives thereof. Suitable polycarboxylates containing two carboxy groups include the water-soluble salts of succinic acid, malonic acid, (ethylenedioxy)diacetic acid, maleic acid, diglycolic acid, tartaric acid, tartronic acid and fumaric acid, as well as the ether carboxylates and the sulphinyl carboxylates. Suitable polycarboxylates containing three carboxy groups include, in particular, water-soluble citrates, aconitrates and citraconates as well as succinate derivatives, lactoxysuccinates, and aminosuccinates, and the oxypolycarboxylate materials such as 2-oxa-1,1,3-propane tricarboxylates. Polycarboxylates containing four carboxy groups include oxydisuccinates, 1,1,2,2-ethane tetracarboxylates, 1,1,3,3-propane tetracarboxylates and 1,1,2,3-propane tetracarboxylates. Suitable polycarboxylates containing sulphur substituents include the sulphosuccinate derivatives, and the sulphonated pyrolysed citrates. Suitable alicyclic and heterocyclic polycarboxylates include cyclopentane-cis,cis,cis-tetracarboxylates, cyclopentadienide pentacarboxylates, 2,3,4,5-tetrahydrofuran-cis,cis,cis-tetracarboxylates, 2,5-tetrahydrofuran-cis-dicarboxylates, 2,2,5,5-tetrahydrofuran-tetracarboxylates, 1,2,3,4,5,6-hexane-hexacarboxylates and carboxymethyl derivatives of polyhydric alcohols such as sorbitol, mannitol and xylitol. Suitable aromatic polycarboxylates include mellitic acid, pyromellitic acid and the phthalic acid derivatives. Of the above, the preferred polycarboxylates are hydroxycarboxylates containing up to three carboxy groups per molecule, more particularly citrates. The parent acids of the monomeric or oligomeric polycarboxylate chelating agents or mixtures thereof with their salts, e.g. citric acid or citrate/citric acid mixtures are also contemplated as useful builder components. Borate builders, as well as builders containing borate-forming materials that can produce borate under detergent storage or wash conditions can also be used. Examples of suitable carbonate builders are the alkaline earth and alkali metal carbonates, preferably the sodium and potassium salts, including sodium carbonate and sesqui-carbonate and mixtures thereof with ultra-fine calcium carbonate. Highly preferred builder compounds for use in the present invention are water-soluble phosphate builders. Specific examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation preferably ranges from 6 to 21, and salts of phytic acid. Specific examples of suitable water-soluble phosphate builders are the alkali metal tripolyphosphates, sodium and potassium and ammonium pyrophosphate, sodium and potassium orthophosphate, sodium polymetaphosphate in which the degree of polymerization preferably ranges from 6 to 21, and salts of phytic acid.

Thus in a preferred embodiment the present invention provides an automatic dishwasher detergent formulation, containing

I) 0-30%, preferably 0-10%, of a surfactant,

II) 0-90%, preferably 0-70%, of a builder/co-builder,

III) 1-99%, preferably 1-50%, of a peroxide or a peroxide-forming substance, and

IV) a metal complex compound of formula (1) in an amount which, in the liquor, gives a concentration of 0.5-200 mg/litre of liquor, when from 0.5 to 20 g/litre of the dishwashing formulation are added to the liquor.

In addition to the bleach catalyst according to formula (1) it is also possible to use further transition metal salts or complexes known as bleach-activating active ingredients and/or conventional bleach activators, that is to say compounds that, under perhydrolysis conditions, yield unsubstituted or substituted perbenzo- and/or peroxo-carboxylic acids having from 1 to 10 carbon atoms, especially from 2 to 4 carbon atoms. Suitable bleach activators include the customary bleach activators that carry O- and/or N-acyl groups having the indicated number of carbon atoms and/or unsubstituted or substituted benzoyl groups. Preference is given to polyacylated alkylenediamines, especially tetraacetylethylenediamine (TAED), acylated glycolurils, especially tetraacetylglycoluril (TAGU), N,N-diacetyl-N,N-dimethylurea (DDU), acylated triazine derivatives, especially 1,5-diacetyl-2,4-dioxohexahydro-1,3,5-triazine (DADHT), compounds of formula (4):

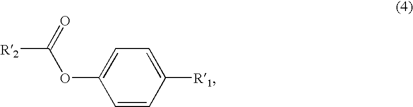

wherein R′₁ is a sulfonate group, a carboxylic acid group or a carboxylate group, and wherein R′₂ is linear or branched (C₇-C₁₅)alkyl, especially activators known under the names SNOBS, SLOBS and DOBA, acylated polyhydric alcohols, especially triacetin, ethylene glycol diacetate and 2,5-diacetoxy-2,5-dihydrofuran, and also acetylated sorbitol and mannitol and acylated sugar derivatives, especially pentaacetylglucose (PAG), sucrose polyacetate (SUPA), pentaacetylfructose, tetraacetylxylose and octaacetyllactose as well as acetylated, optionally N-alkylated glucamine and gluconolactone. It is also possible to use the combinations of conventional bleach activators known from German Patent Application DE-A-44 43 177. Nitrile compounds that form perimine acids with peroxides also come into consideration as bleach activators.

The formulation may comprise an additional component which is typically associated with an automatic dishwasher detergent. Preferred examples of such additional components includes preservatives such as isothiazolinone, dyes, corrosion inhibitors (both dishwasher machine and glass/kitchenware corrosion inhibitors), perfumes, stability aids and dispersing aids.

The formulation according to the invention may take the form of a complete dishwashing detergent or in the alternative may take the form of a separate bleaching additive. In the latter case the bleaching additive may used for removing coloured stains on crockery/kitchenware in a separate liquor before the items are washed in a dishwasher. The bleaching additive can also be used in a liquor together with either a bleach-free washing agent or a bleach-containing washing agent as a bleach booster.

The formulation according to the invention may be in solid or liquid form. The liquid may be homogenous or multi-phase. One or more of the formulation components may be present in the form of a suspension.

When in liquid form the formulation may comprise a thickener, such as is commonly use to increase the viscosity of the formulation and appeal to the consumer. Preferred examples of such thickeners include Xantham gum, cellulose derivatives and polyacrylic acid derivatives. A preferred commercially available thickener is sold under the tradename Carbopol (available from BF Goodrich).

The formulation may be in the form of a powder. The powder may also be compressed into tablet form. If in tablet form the formulation may include a tabletting aid such as polyethyleneglycol.

The formulation may comprise granules of the metal catalyst of formula (1). Such granules preferably comprise:
a) from 1 to 99% by weight, preferably from 1 to 40% by weight, especially from 1 to 30% by weight, of a metal complex compound of formula (1), especially of formula (1a),
b) from 1 to 99% by weight, preferably from 10 to 99% by weight, especially from 20 to 80% by weight, of a binder,
c) from 0 to 20% by weight, especially from 1 to 20% by weight, of an encapsulating material,
d) from 0 to 20% by weight of a further additive and
e) from 0 to 20% by weight of water.

As binder (b) there come into consideration anionic dispersants, non-ionic dispersants, polymers and waxes that are water-soluble, dispersible or emulsifiable in water.

The anionic dispersants used are, for example, commercially available water-soluble anionic dispersants for dyes, pigments etc.

The following products, especially, come into consideration:

condensation products of aromatic sulfonic acids and formaldehyde, condensation products of aromatic sulfonic acids with unsubstituted or chlorinated diphenylene or diphenyl oxides and optionally formaldehyde, (mono-/di-)alkylnaphthalenesulfonates, sodium salts of polymerised organic sulfonic acids, sodium salts of polymerised alkylnaphthalenesulfonic acids, sodium salts of polymerised alkylbenzenesulfonic acids, alkylarylsulfonates, sodium salts of alkyl polyglycol ether sulfates, polyalkylated polynuclear arylsulfonates, methylene-linked condensation products of arylsulfonic acids and hydroxyarylsulfonic acids, sodium salts of dialkylsulfosuccinic acids, sodium salts of alkyl diglycol ether sulfates, sodium salts of polynaphthalenemethane-sulfonates, lignosulfonates or oxylignosulfonates or heterocyclic polysulfonic acids.

Especially suitable anionic dispersants are condensation products of naphthalenesulfonic acids with formaldehyde, sodium salts of polymerised organic sulfonic acids, (mono-/di-)alkylnaphthalenesulfonates, polyalkylated polynuclear arylsulfonates, sodium salts of polymerised alkylbenzenesulfonic acids, lignosulfonates, oxylignosulfonates and condensation products of naphthalenesulfonic acid with a polychloromethyldiphenyl.

Suitable non-ionic dispersants are especially compounds having a melting point of, preferably, at least 35° C. that are emulsifiable, dispersible or soluble in water, for example the following compounds:
1. fatty alcohols having from 8 to 22 carbon atoms, especially cetyl alcohol;
2. addition products of, preferably, from 2 to 80 mol of alkylene oxide, especially ethylene oxide, wherein some of the ethylene oxide units may have been replaced by substituted epoxides, such as styrene oxide and/or propylene oxide, with higher unsaturated or saturated monoalcohols, fatty acids, fatty amines or fatty amides having from 8 to 22 carbon atoms or with benzyl alcohols, phenyl phenols, benzyl phenols or alkyl phenols, the alkyl radicals of which have at least 4 carbon atoms;
3. alkylene oxide, especially propylene oxide, condensation products (block polymers);
4. ethylene oxide/propylene oxide adducts with diamines, especially ethylenediamine;
5. reaction products of a fatty acid having from 8 to 22 carbon atoms and a primary or secondary amine having at least one hydroxy-lower alkyl or lower alkoxy-lower alkyl group, or alkylene oxide addition products of such hydroxyalkyl-group-containing reaction products;
6. sorbitan esters, preferably with long-chain ester groups, or ethoxylated sorbitan esters, such as polyoxyethylene sorbitan monolaurate having from 4 to 10 ethylene oxide units or polyoxyethylene sorbitan trioleate having from 4 to 20 ethylene oxide units;
7. addition products of propylene oxide with a tri- to hexa-hydric aliphatic alcohol having from 3 to 6 carbon atoms, e.g. glycerol or pentaerythritol; and
8. fatty alcohol polyglycol mixed ethers, especially addition products of from 3 to 30 mol of ethylene oxide and from 3 to 30 mol of propylene oxide with aliphatic monoalcohols having from 8 to 22 carbon atoms.

Especially suitable non-ionic dispersants are surfactants of formula
R′₁₁-O-(alkylene-O)ₙ—R′₁₂ (5),

wherein

R′₁₁ is C₈-C₂₂alkyl or C₈-C₁₈alkenyl;

R′₁₂ is hydrogen; C₁-C₄alkyl; a cycloaliphatic radical having at least 6 carbon atoms; or benzyl;

“alkylene” is an alkylene radical having from 2 to 4 carbon atoms and

n is a number from 1 to 60.

A substituent R′₁₁ or R′₁₂ in formula (5) is advantageously the hydrocarbon radical of an unsaturated or, preferably, saturated aliphatic monoalcohol having from 8 to 22 carbon atoms. The hydrocarbon radical may be straight-chain or branched. R′₁₁ and R′₁₂ are preferably each independently of the other an alkyl radical having from 9 to 14 carbon atoms.

Aliphatic saturated monoalcohols that come into consideration include natural alcohols, e.g. lauryl alcohol, myristyl alcohol, cetyl alcohol or stearyl alcohol, and also synthetic alcohols, e.g. 2-ethylhexanol, 1,1,3,3-tetramethylbutanol, octan-2-ol, isononyl alcohol, trimethylhexanol, trimethylnonyl alcohol, decanol, C₉-C₁₁oxo-alcohol, tridecyl alcohol, isotridecyl alcohol and linear primary alcohols (Alfols) having from 8 to 22 carbon atoms. Some examples of such Alfols are Alfol (8-10), Alfol (9-11), Alfol (10-14), Alfol (12-13) and Alfol (16-18). (“Alfol” is a registered trade mark).

Unsaturated aliphatic monoalcohols are, for example, dodecenyl alcohol, hexadecenyl alcohol and oleyl alcohol.

The alcohol radicals may be present singly or in the form of mixtures of two or more components, e.g. mixtures of alkyl and/or alkenyl groups that are derived from soybean fatty acids, palm kernel fatty acids or tallow oils.

(Alkylene-O) chains are preferably divalent radicals of the formulae

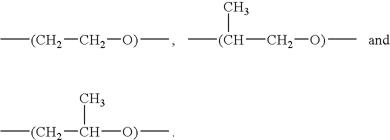

Examples of a cycloaliphatic radical are cycloheptyl, cyclooctyl and preferably cyclohexyl.

As non-ionic dispersants there come into consideration especially surfactants of formula

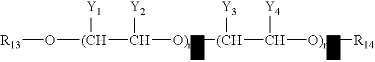

wherein

R₁₃ is C₈-C₂₂alkyl;

R₁₄ is hydrogen or C₁-C₄alkyl;

Y₁, Y₂, Y₃ and Y₄ are each independently of the others hydrogen, methyl or ethyl;

n₂ is a number from 0 to 8; and

n₃ is a number from 2 to 40.

Further important non-ionic dispersants correspond to formula

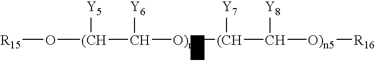

wherein R₁₅ is C₉-C₁₄alkyl; R₁₆ is C₁-C₄alkyl; Y₅, Y₆, Y₇ and Y₈ are each independently of the others hydrogen, methyl or ethyl, one of the radicals Y₅, Y₆ and one of the radicals Y₇, Y₈ always being hydrogen; and n₄ and n₅ are each independently of the other an integer from 4 to 8.

The non-ionic dispersants of formulae (5) to (7) can be used in the form of mixtures. For example, as surfactant mixtures there come into consideration non-end-group-terminated fatty alcohol ethoxylates of formula (5), e.g. compounds of formula (5) wherein

R₁₁ is C₈-C₂₂alkyl,

R₁₂ is hydrogen and

the alkylene-O chain is the radical —(CH₂—CH₂—O)— and also end-group-terminated fatty alcohol ethoxylates of formula (7).

Examples of non-ionic dispersants of formulae (5), (6) and (7) include reaction products of a C₁₀-C₁₃fatty alcohol, e.g. a C₁₃oxo-alcohol, with from 3 to 10 mol of ethylene oxide, propylene oxide and/or butylene oxide or the reaction product of one mol of a C₁₃fatty alcohol with 6 mol of ethylene oxide and 1 mol of butylene oxide, it being possible for the addition products each to be end-group-terminated with C₁-C₄alkyl, preferably methyl or butyl.

Such dispersants can be used singly or in the form of mixtures of two or more dispersants.

Instead of, or in addition to, the anionic or non-ionic dispersant, the granules may comprise a water-soluble organic polymer as binder. Such polymers may be used singly or in the form of mixtures of two or more polymers.

Water-soluble polymers that come into consideration are, for example, polyethylene glycols, copolymers of ethylene oxide with propylene oxide, gelatin, polyacrylates, polymethacrylates, polyvinylpyrrolidones, vinylpyrrolidones, vinyl acetates, polyvinylimidazoles, polyvinylpyridine-N-oxides, copolymers of vinylpyrrolidone with long-chain α-olefins, copolymers of vinylpyrrolidone with vinylimidazole, poly(vinylpyrrolidone/dimethylaminoethyl methacrylates), copolymers of vinylpyrrolidone/dimethylaminopropyl methacrylamides, copolymers of vinylpyrrolidone/dimethylaminopropyl acrylamides, quaternised copolymers of vinylpyrrolidones and dimethylaminoethyl methacrylates, terpolymers of vinylcaprolactam/vinylpyrrolidone/dimethylaminoethyl methacrylates, copolymers of vinylpyrrolidone and methacrylamidopropyl-trimethylammonium chloride, terpolymers of caprolactam/vinylpyrrolidone/dimethylaminoethyl methacrylates, copolymers of styrene and acrylic acid, polycarboxylic acids, polyacrylamides, carboxymethylcellulose, hydroxymethylcellulose, polyvinyl alcohols, polyvinyl acetate, hydrolysed polyvinyl acetate, copolymers of ethyl acrylate with methacrylate and methacrylic acid, copolymers of maleic acid with unsaturated hydrocarbons, and also mixed polymerisation products of the mentioned polymers.

Of those organic polymers, special preference is given to polyethylene glycols, carboxymethylcellulose, polyacrylamides, polyvinyl alcohols, polyvinylpyrrolidones, gelatin, hydrolysed polyvinyl acetates, copolymers of vinylpyrrolidone and vinyl acetate, and also polyacrylates, copolymers of ethyl acrylate with methacrylate and methacrylic acid, and polymethacrylates.

Suitable water-emulsifiable or water-dispersible binders also include paraffin waxes.

Encapsulating materials (c) include especially water-soluble and water-dispersible polymers and waxes. Of those materials, preference is given to polyethylene glycols, polyamides, polyacrylamides, polyvinyl alcohols, polyvinylpyrrolidones, gelatin, hydrolysed polyvinyl acetates, copolymers of vinylpyrrolidone and vinyl acetate, and also polyacrylates, paraffins, fatty acids, copolymers of ethyl acrylate with methacrylate and methacrylic acid, and polymethacrylates.

Further additives (d) that come into consideration are, for example, wetting agents, dust removers, water-insoluble or water-soluble dyes or pigments, and also dissolution accelerators and sequestering agents.

The preparation of the granules may be carried out, for example, starting from:
a) a solution or suspension with a subsequent drying/shaping step or
b) a suspension of the active ingredient in a melt with subsequent shaping and solidification.

a) First of all the anionic or non-ionic dispersant and/or the polymer and, if appropriate, the further additives are dissolved in water and stirred, if desired with heating, until a homogeneous solution has been obtained. The metal catalyst is then dissolved or suspended in the resulting aqueous solution. The solids content of the solution should preferably be at least 30% by weight, especially 40 to 50% by weight, based on the total weight of the solution. The viscosity of the solution is preferably less than 200 mPas.

The aqueous solution so prepared, comprising the metal catalyst is then subjected to a drying step in which all water, with the exception of a residual amount, is removed, solid particles (granules) being formed at the same time. Known methods are suitable for producing the granules from the aqueous solution. In principle, both continuous methods and discontinuous methods are suitable. Continuous methods are preferred, especially spray-drying and fluidised bed granulation processes.

Especially suitable are spray-drying processes in which the active ingredient solution is sprayed into a chamber with circulating hot air. The atomisation of the solution is effected e.g. using unitary or binary nozzles or is brought about by the spinning effect of a rapidly rotating disc. In order to increase the particle size, the spray-drying process may be combined with an additional agglomeration of the liquid particles with solid nuclei in a fluidised bed that forms an integral part of the chamber (so-called fluid spray). The fine particles (<100 μm) obtained by a conventional spray-drying process may, if necessary after being separated from the exhaust gas flow, be fed as nuclei, without further treatment, directly into the atomizing cone of the atomiser of the spray-dryer for the purpose of agglomeration with the liquid droplets of the active ingredient.

During the granulation step, the water can rapidly be removed from the solutions comprising the catalyst according to the invention, binder and further additives. It is expressly intended that agglomeration of the droplets forming in the atomising cone, or the agglomeration of droplets with solid particles, will take place.

If necessary, the granules formed in the spray-dryer are removed in a continuous process, for example by a sieving operation. The fines and the oversize particles are either recycled directly to the process (without being redissolved) or are dissolved in the liquid active ingredient formulation and subsequently granulated again.

A further preparation method according to a) is a process in which the polymer is mixed with water and then the catalyst is dissolved/suspended in the polymer solution, thus forming an aqueous phase, the catalyst being homogeneously distributed in that phase. At the same time or subsequently, the aqueous phase is dispersed in a water-immiscible liquid in the presence of a dispersion stabiliser in order that a stable dispersion is formed. The water is then removed from the dispersion by distillation, forming substantially dry particles. In those particles, the catalyst is homogeneously distributed in the polymer matrix.

The granules are preferably wear-resistant, low in dust, pourable and readily meterable. They can be added directly to the dishwasher detergent formulation in a desired concentration.

Where the coloured appearance of the granules is to be suppressed, this can be achieved, for example, by embedding the granules in a droplet of a whitish meltable substance (“water-soluble wax”) or by adding a white pigment (e.g. TiO₂) to the granule formulation or, preferably, by encapsulating the granules in a melt consisting, for example, of a water-soluble wax, as described in EP-A-0 323 407, a white solid being added to the melt in order to reinforce the masking effect of the capsule.

b) The catalyst may be dried in a separate step prior to the melt-granulation and, if necessary, dry-ground in a mill so that all the solids particles are smaller than 50 μm in size. The drying is carried out in an apparatus customary for the purpose, for example in a paddle dryer, vacuum cabinet or freeze-dryer.

The finely particulate catalyst is suspended in the molten carrier material and homogenised. The desired granules are produced from the suspension in a shaping step with simultaneous solidification of the melt. The choice of a suitable melt-granulation process is made in accordance with the desired size of granules. In principle, any process which can be used to produce granules in a particle size of from 0.1 to 4 mm is suitable. Such processes are droplet processes (with solidification on a cooling belt or during free fall in cold air), melt-prilling (cooling medium gas/liquid), and flake formation with a subsequent comminution step, the granulation apparatus being operated continuously or discontinuously.

Where the coloured appearance of the granules prepared from a melt is to be suppressed, in addition to the catalyst it is also possible to suspend in the melt white or coloured pigments which, after solidification, impart the desired coloured appearance to the granules (e.g. titanium dioxide).

If desired, the granules can be covered or encapsulated in an encapsulating material. Methods suitable for such an encapsulation include the customary methods and also the encapsulation of the granules by a melt consisting e.g. of a water-soluble wax, as described, for example, in EP-A-0 323 407, coacervation, complex coacervation and surface polymerisation.

Encapsulating materials (c) include e.g. water-soluble, water-dispersible or water-emulsifiable polymers and waxes.

Further additives (d) include e.g. wetting agents, dust-removers, water-insoluble or water-soluble dyes or pigments, and also dissolution accelerators, optical brighteners and sequestering agents.

The invention is illustrated by the following non-limiting Examples.

### EXAMPLES

### SYNTHESIS OF 4′-SUBSTITUTED TERPYRIDINES AND 4-PYRIDONES

### Example 1

### 1′H-[2,2′;6′,2″]Terpyridin-4′-one

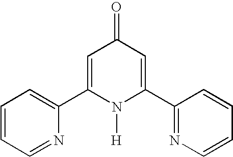 [0168] a) Step 1:

In a nitrogen atmosphere, under reflux, a solution of 20.2 ml (22.7 g, 150 mmol) of pyridine-2-carboxylic acid ethyl ester and 3.6 ml (50 mmol) of dry acetone in 100 ml of dry tetrahydrofuran is added in the course of 4 hours to a suspension of 6 g (approximately 60% dispersion in paraffin oil, about 150 mmol) of sodium hydride in 100 ml of dry tetrahydrofuran. The mixture is boiled at reflux for a further 2 hours and then concentrated using a rotary evaporator. After the addition of 200 ml of ice-water, the mixture is rendered neutral with 50% strength acetic acid and the resulting yellow 1,5-di-pyridin-2-yl-pentane-1,3,5-trione is filtered off. IR (cm⁻¹) : 2953 (s); 2923 (vs) ; 2854 (m) ; 1605 (m); 1560 (s); 1447 (w); 1433 (w); 1374 (m); 1280 (w); 786 (w).
b) Step 2:

A mixture of 10 g (37 mmol) of 1,5-di-pyridin-2-yl-pentane-1,3,5-trione and 20 g (260 mmol) of ammonium acetate is boiled under reflux in 250 ml of ethanol for 8 hours. The mixture so obtained is concentrated to about half its volume. After filtration, 1′H-[2,2′;6′,2 ″]terpyridine-4′-one is obtained in the form of a white solid. ¹H-NMR (360 MHz, DMSO-d6): 7.40-7.50 (qm, 2H); 7.87 (s, 2H); 7.92-8.0 (tm, 2H); 8.57 (d, 2H, 7.7 Hz); 8.68 (d, 2H, J=4.5 Hz), 10.9 (s, 1H). MS (EI pos., 70 eV), m/z=249 (100, [M⁺]) ; 221 (40).

(for preparation see also K. T. Potts, D. Konwar, J. Org. Chem. 2000, 56, 4815-4816 and E. C. Constable, M. D. Ward, J. Chem. Soc. Dalton Trans. 1990, 1405-1409).

### Example 2

### 2-(Methyl-[2,2′;6′,2″]terpyridin-4′-yl-amino)-ethanol

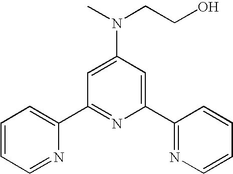

A mixture of 3.99 g (16 mmol) of 1′H-[2,2′;6′,2″]terpyridin-4′-one and 8.0 g (38 mmol) of phosphorus pentachloride is boiled at reflux in 200 ml of phosphorus oxychloride for sixteen hours. The mixture is allowed to cool and concentrated to dryness. 200 ml of ice-water are then added cautiously to the residue, and the solution is then adjusted to pH 9 with aqueous potassium hydroxide solution. Extraction is carried out three times using chloroform and the organic extracts are dried over sodium sulfate, filtered and concentrated. After recrystallisation from ethanol, 4′-chloro-[2,2′;6′,2″]terpyridine is obtained in the form of white needles.

A solution in 20 ml of dichloromethane of 1.61 g (6 mmol) of 4′-chloro-2,2′:6′,2″-terpyridine and 20 ml of N-methylaminoethanol are added in succession to a solution of 1.35 g (6.8 mmol) of iron(II) chloride tetrahydrate in 100 ml of isopropanol. The mixture is then boiled at reflux for 20 hours. The mixture is concentrated and a solution of 1.66 g of ammonium hexafluorophosphate in 10 ml of methanol is added. The resulting violet precipitate is washed four times using 50 ml of diethyl ether each time and once with 50 ml of water. The residue is then stirred for 14 hours in a solution of 4 g of sodium hydroxide in 300 ml of water/acetonitrile (1:1 v/v) in an oxygen atmosphere. Filtration is carried out over kieselguhr and the residue is washed with 50 ml of water, 50 ml of acetonitrile and 100 ml of dichloromethane. The filtrates are concentrated. Extraction is carried out four times with dichloromethane and the combined organic extracts are dried over sodium sulfate, filtered and concentrated. The residue is recrystallised from acetone/petroleum ether and acetonitrile; 2-(methyl-[2,2′;6′,2″]terpyridin-4′-yl-amino)-ethanol is obtained in the form of a white solid. MS (ESI pos., KF), m/z=345 (100, [M+K]⁺); 307 (35, [M+H]⁺).

(for preparation see also G. Lowe et al., J. Med. Chem., 1999, 42, 999-1006).

### SYNTHESIS OF METAL COMPLEXES WITH TERPYRIDINE LIGANDS AND 4-PYRIDONE LIGANDS

### Example 3

### Manganese(II) complex containing a pyridone ligand: {[2,2′;6′,2″]terpyridin-4′-ol}manganese(II) chloride

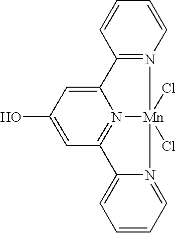

198 mg (1 mmol) of manganese(II) chloride tetrahydrate are dissolved in 10 ml of ethanol, and 249 mg (1 mmol) of 1′H-(2,2′;6′,2″]terpyridin-4′-one are added. The mixture is stirred for 24 hours at room temperature and filtered, and the light-yellow solid is dried in vacuo. C₁₅H₁₁Cl₂MnN₃O, 375.12; calculated C, 48.03; H, 2.96; N, 11.20; Mn, 14.65; found C, 48.22; H, 3.14; N, 11.13; Mn, 14.6. IR (cm⁻¹): 3082 (br, vs), 1613 (s), 1600 (s), 1558 (s), 1429 (m), 1224 (s), 1011 (m), 798 (m).

### Example 4

### {2-(Methyl-[2,2′;6′,2″]terpyridin-4′-yl-amino)-ethanol}manganese(II) chloride

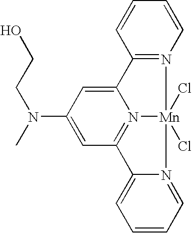

7.66 g (25 mmol) of 2-(methyl[2,2′;6′,2″]terpyridin-4′-yl-amino)ethanol are added, in five portions, over a period of 30 minutes to 100 ml of an ethanolic manganese(II) chloride tetrahydrate solution (4.95 g, 25 mmol). The mixture is diluted with 70 ml of ethanol, stirred for 18 hours at room temperature and filtered, and the light-yellow solid is dried in vacuo. C₁₈H₁₈Cl₂MnN₄O; calculated C, 50.02; H, 4.20; N, 12.96; Mn, 12.71; Cl, 16.41; found C, 49.90; H, 4.12; N, 12.78; Mn, 12.9 Cl 16.33.

### APPLICATION EXAMPLES

### Application Examples 1&2

A composition for use in a dishwashing machine was made without the use of bleaching components. This composition is shown below.

| | | Content |
|---|---|---|
| Raw material | Function | (wt %) |
| Sodium tripolyphosphate | Builder | 70.2890 |
| Hexametaphosphate | Builder | 4.6620 |
| Sodium bicarbonate | Alkali source | 0.1748 |
| Sodium carbonate | Alkali source | 11.4382 |
| Polyethyleneglycol | Tabletting aid | 3.2727 |
| HEDP | Phosphonate/crystal | 0.2331 |
| | growth inhibition | |
| Acrylic acid homopolymer | Polymer/crystal growth | 1.1655 |
| | inhibition | |
| Purastar activity 4000 | Amylase | 0.8625 |
| Properase activity 4000 | Protease | 1.2821 |
| Sanolin Blue | Dye | 0.0070 |
| Nonionic (EO/PO) | Surfactant | 4.7016 |
| Benzotriazole (BTA) | Silver corrosion | 0.2890 |
| granular | inhibitor | |
| Glycerol (99%) | Solvent | 1.4918 |
| Fragrance | Fragrance | 0.1305 |
| | | 100.0000 |

To this base bleach components were added (as shown in tables 1 & 2).

The bleach performance of the resulting compositions were then tested according to IKW method (IKW-Arbeitskreis Maschinenspülmittel, “Methoden zur Bestimmung der Reinigungsleistung von maschinellen Geschirrspülmitteln (Part A and B)”, SÖFW, 11+14, 1998).

The cleaning of bleach-able stains using a dishwashing tablet containing a metal catalyst and per-oxygen source was compared to the performance of a composition containing the base and per-oxygen source and also with a tablet containing a commercialy available activator (TAED).

Cleaning was tested in a Bosch SMS 5062 dishwashing machine using a 55° C. cycle. In each case a tablet comprising 23 g of the formulation was added at the start of the dishwasher main wash cycle. The water hardness was 21° gH. The results (given in each of tables 1 and 2) are expressed as a percentage improvement in the treatment of bleach-able stains when using the composition according to the invention versus the comparison composition.

TABLE 1

| | | | Metal | Stain |
|---|---|---|---|---|
| | | | Catalyst | Removal |
| | Tablet | Metal | Content | Improvement |
| Example | Composition | Catalyst | (ppm) | (%) |
| 1 | Base + 10% | — | — | — |
| | Perborate | | | |
| | Base + 10% | Example 3 | 10 | 5 |
| | Perborate | | | |

TABLE 2

| | | | Metal | Stain |
|---|---|---|---|---|
| | | | Catalyst | Removal |
| | Tablet | Metal | Content | Improvement |
| Example | Composition | Catalyst | (ppm) | (%) |
| 2 | Base + 15% | — | — | — |
| | Perborate | | | |
| | (w/w) + 3% | | | |
| | TAED (w/w) | | | |
| | Base + 15% | Example 3 | 10 | 39 |
| | Perborate | | | |
| | (w/w) + 3% | | | |
| | TAED (w/w) | | | |

### Application Example 3

As in Examples 1&2 the performance of a base formulation was tested on bleach-able stains and the performance compared with a formulation comprising a metal catalyst, ie. a formulation in accordance with the invention. In this Example the water hardness was 9° gH. The base formulation is shown below.

| | | Content |
|---|---|---|
| Raw Material | Function | (wt %) |
| Disilicate | Alkali source | 2.76 |
| Sodium tripolyphosphate | Builder | 52.17 |
| Sodium carbonate | Alkali source | 40.61 |
| Acrylic acid homopolymer | Polymer/crystal | 1.09 |
| | growth inhibition | |
| Everlase activity 2000 | Protease | 1.41 |
| Purastar activity 4000 | Amylase | 0.43 |
| Nonionic (EO/PO) | Surfactant | 1.09 |
| Benzotriazol (BTA) Granular | Silver corrosion | 0.27 |
| | inhibitor | |
| Fragrance | Fragrance | 0.16 |
| | | 100.00 |

20 g of the powder formulation was dosed into the main wash cycle of the dishwasher. The results are shown in table 3.

TABLE 3

| | | Metal | Stain |
|---|---|---|---|
| | | Catalyst | Removal |
| Powder | Metal | Content | Improvement |
| Composition | Catalyst | (ppm) | (%) |
| Base + 6% | — | — | — |
| Percarbonate | | | |
| Base + 6% | Example 3 | 200 | 5 |
| Percarbonate | | | |

### Application Example 4

As in Examples 1&2 the performance of a base formulation was tested on bleach-able stains and the performance compared with a formulation comprising a metal catalyst, ie. a formulation in accordance with the invention. In this Example the water hardness was 9° gH. The base formulation is shown below.

| Raw Material | Function | Content (wt %) |
|---|---|---|
| Trisodium citrate | Builder | 51.10 |
| Sodium bicarbonate | Alkali source | 35.22 |
| Sodium carbonate | Alkali source | 6.48 |
| Acrylic acid homopolymer | Polymer/crystal | 3.85 |
| | growth inhibition | |
| Everlase activity 2000 | Protease | 1.43 |
| Purastar activity 4000 | Amylase | 0.44 |
| HEDP | Phosphonate/ | 0.22 |
| | crystal growth | |
| | inhibition | |
| Nonionic (EO/PO) | Surfactant | 0.82 |
| Benzotriazol (BTA) Granular | Silver corrosion | 0.27 |
| | inhibitor | |
| Fragrance | Fragrance | 0.16 |
| | | 100.00 |

20 g of the powder formulation was dosed into the main wash cycle of the dishwasher. The results are shown in table 4.

TABLE 4

| | | Metal | Stain |
|---|---|---|---|
| | | Catalyst | Removal |
| Powder | Metal | Content | Improvement |
| Composition | Catalyst | (ppm) | (%) |
| Base + 7% | — | — | — |
| Percarbonate | | | |
| Base + 7% | Example 3 | 200 | 41 |
| Percarbonate | | | |

### Application Example 5

As in Examples 1&2 the performance of a base formulation was tested on bleach-able stains and the performance compared with a formulation comprising a metal catalyst, i.e. a formulation in accordance with the invention. In this Example the water hardness was 9° gH. The base formulation is shown below.

| Raw Material | Function | Content (wt %) |
|---|---|---|
| Trisodium citrate | Builder | 51.10 |
| Sodium bicarbonate | Alkali source | 35.22 |
| Sodium carbonate | Alkali source | 6.48 |
| Acrylic acid homopolymer | Polymer/crystal | 3.85 |
| | growth inhibition | |
| Everlase activity 2000 | Protease | 1.43 |
| Purastar activity 4000 | Amylase | 0.44 |
| HEDP | Phosphonate/ | 0.22 |
| | crystal growth | |
| | inhibition | |
| Nonionic (EO/PO) | Surfactant | 0.82 |
| Benzotriazol (BTA) Granular | Silver corrosion | 0.27 |
| | inhibitor | |
| Fragrance | Fragrance | 0.16 |
| | | 100.00 |

20 g of the powder formulation was dosed into the main wash cycle of the dishwasher. The results are shown in table 5.

TABLE 5

| | | | Stain Removal |
|---|---|---|---|
| Powder | Metal | Metal Catalyst | Improvement |
| Composition | Catalyst | Content (ppm) | (%) |
| Base + 14% | — | — | — |
| Percarbonate | | | |
| (w/w) + 2% | | | |
| TAED (w/w) | | | |
| Base + 14% | Example 4 | 100 | 61 |
| Percarbonate | | | |
| (w/w) + 2% | | | |
| TAED (w/w) | | | |

1. An automatic dishwasher detergent formulation comprising:
(a) a metal complex compounds of formula (1)
[LₙMeₘXₚ]^{z}Y_{q} (1),
wherein Me is manganese, titanium, iron, cobalt, nickel or copper,
X is a co-ordinating or bridging radical,
n and m are each independently of the other an integer having a value of from 1 to 8,
p is an integer having a value of from 0 to 32,
z is the charge of the metal complex,
Y is a counter-ion,
q=z/(charge Y), and
L is a ligand of formula (2) 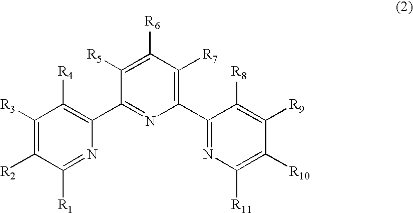
wherein
R₁, R₂, R₃, R₄, R₅, R₆, R₇, R₈, R₉, R₁₀ and R₁₁ are each independently of the others hydrogen; unsubstituted or substituted C₁-C₁₈alkyl or aryl; cyano; halogen; nitro; —COOR₁₂ or —SO₃R₁₂ wherein R₁₂ is in each case hydrogen, a cation or unsubstituted or substituted C₁-C₁₈alkyl or aryl; —SR₁₃, —SO₂R₁₃ or —OR₁₃ wherein R₁₃ is in each case hydrogen or unsubstituted or substituted C₁-C₁₈alkyl or aryl; —N(R₁₃)—NR′₁₃R″₁₃ wherein R₁₃, R′₁₃ and R″₁₃ are as defined above for R₁₃; —NR₁₄R₁₅ or —N^{⊕}R₁₄R₁₅R₁₆ wherein R₁₄,
R₁₅ and R₁₆ are each independently of the other(s) hydrogen or unsubstituted or substituted C₁-C₁₈alkyl or aryl, or R₁₄ and R₁₅ together with the nitrogen atom bonding them form an unsubstituted or substituted 5-, 6- or 7-membered ring which may optionally contain further hetero atoms;
with the proviso that R₁, R₂, R₃, R₄, R₅, R₆, R₇, R₈, R₉, R₁₀ and R₁₁ are not simultaneously hydrogen, as a catalyst for oxidation reactions; and
(b) an enzyme.

2. A formulation according to claim 1, wherein Me is manganese which is present in oxidation state II, III, IV or V.

3. A formulation according to claim 1, wherein
X is CH₃CN, H₂O, F⁻, Cl⁻, Br⁻, HOO⁻, O₂²⁻, O²⁻, R₁₇COO⁻, R₁₇O⁻, LMeO⁻ or LMeOO⁻ wherein R₁₇ is hydrogen or unsubstituted or substituted C₁-C₁₈alkyl or aryl.

4. A formulation according to claim 1, wherein Y is R₁₇COO⁻, ClO₄⁻, BF₄⁻, PF₆⁻, R₁₇SO₃⁻, R₁₇SO₄⁻, SO₄²⁻, NO₃⁻, F⁻, Cl⁻, Br⁻ or I⁻ wherein R₁₇ is hydrogen or unsubstituted or substituted C₁-C₁₈alkyl or aryl.

5. A formulation according to claim 1, wherein n is an integer having a value of from 1 to 4, especially 1 or 2.

6. A formulation according to claim 1, wherein m is an integer having a value of 1 or 2, especially 1.

7. A formulation according to claim 1, wherein p is an integer having a value of from 0 to 4, especially 2.

8. A formulation according to claim 1, wherein z is an integer having a value of from 8− to 8+.

9. A formulation according to claim 1, wherein aryl is phenyl or naphthyl unsubstituted or substituted by C₁-C₄alkyl, C₁-C₄alkoxy, halogen, cyano, nitro, carboxyl, sulfo, hydroxyl, amino, N-mono- or N,N-di-C₁-C₄alkylamino unsubstituted or substituted by hydroxy in the alkyl moiety, N-phenylamino, N-naphthylamino, phenyl, phenoxy or by naphthoxy.

10. A formulation according to claim 1, wherein the 5-, 6- or 7-membered ring formed by R₁₄ and R₁₅ together with the nitrogen atom bonding them is an unsubstituted or C₁-C₄alkyl-substituted pyrrolidine, piperidine, piperazine, morpholine or azepane ring.

11. A formulation according to claim 1, wherein R₆ is C₁-C₁₂alkyl; phenyl unsubstituted or substituted by C₁-C₄alkyl, C₁-C₄alkoxy, halogen, cyano, nitro, carboxyl, sulfo, hydroxyl, amino, N-mono- or N,N-di-C₁-C₄alkylamino unsubstituted or substituted by hydroxy in the alkyl moiety, N-phenylamino, N-naphthylamino, phenyl, phenoxy or by naphthoxy; cyano; halogen; nitro; —COOR₁₂ or —SO₃R₁₂ wherein R₁₂ is in each case hydrogen, a cation, C₁-C₁₂alkyl, or phenyl unsubstituted or substituted as indicated above; —SR₁₃, —SO₂R₁₃ or —OR₁₃ wherein R₁₃ is in each case hydrogen, C₁-C₁₂alkyl, or phenyl unsubstituted or substituted as indicated above; —N(R₁₃)—NR′₁₃R″¹³ wherein R₁₃, R′₁₃ and R″₁₃ are as defined above for R₁₃; —NR₁₄R₁₅ or —N^{⊕}R₁₄R₁₅R₁₆ wherein R₁₄, R₁₅ and R₁₆ are each independently of the other(s) hydrogen, unsubstituted or hydroxyl-substituted C₁-C₁₂alkyl, or phenyl unsubstituted or substituted as indicated above, or R₁₄ and R₁₅ together with the nitrogen atom bonding them form an unsubstituted or C₁-C₄alkyl-substituted pyrrolidine, piperidine, piperazine, morpholine or azepane ring; and R₁, R₂, R₃, R₄, R₅, R₇, R₈, R₉, R₁₀ and R₁₁ are as defined above or are hydrogen.

12. A formulation according to claim 11, wherein the ligand L is a compound of formula 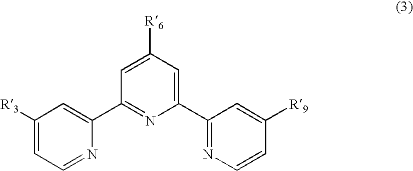
wherein
R′₃, R′₆ and R′₉ are as defined for R₆ in claim 11.

13. A formulation according to claim 12, wherein
R′₃, R′₆ and R′₉ are each independently of the others C₁-C₄alkoxy; hydroxy; phenyl unsubstituted or substituted by C₁-C₄alkyl, C₁-C₄alkoxy, phenyl or by hydroxy; hydrazino; amino; N-mono- or N,N-di-C₁-C₄alkylamino unsubstituted or substituted by hydroxy in the alkyl moiety; or an unsubstituted or C₁-C₄alkyl-substituted pyrrolidine, piperidine, piperazine, morpholine or azepane ring.

14. A formulation according to claim 13, wherein R₆ is hydroxy.

15. A formulation according to claim 14, wherein a metal complex compound of formula (1) is formed in situ in the dishwashing operation.

16. A formulation according to claim 1, wherein the enzyme is a protease.

17. A formulation according to claim 1, wherein the enzyme is separated from a component of the formulation.

18. A formulation according to claim 17 wherein the enzyme is encapsulated.

19. A formulation according to claim 1, wherein the metal complex compounds of formula (1) is a bleach activation catalyst.

20. A formulation according to claim 19, wherein the formulation comprises an additional bleach-activating component.

21. A formulation according to claim 1, wherein the formulation comprises a builder.

22. A formulation according to claim 1, wherein the formulation comprises a surfactant.

23. A formulation according to claim 22, wherein the surfactant is a nonionic low sudsing surfactant.

24. A formulation according to claim 1, wherein the formulation comprises an oxygen source.

25. A formulation according to claim 24, wherein the oxygen source is perborate, percarbonate, hydrogen peroxide or a mixture thereof.

26. An automatic dishwasher detergent formulation, containing
I) 0-30%, preferably 0-10%, of a surfactant,
II) 0-90%, preferably 0-70%, of a builder/co-builder,
III) 1-99%, preferably 1-50%, of a peroxide or a peroxide-forming substance, and
IV) a metal complex compound of formula (1) in an amount which, in the liquor, gives a concentration of 0.5-200 mg/litre of liquor, when from 0.5 to 20 g/litre of the dishwashing formulation are added to the liquor.

27. A formulation according to claim 1, wherein the formulation is in the form of a tablet.

28. Use of a formulation according to claim 1, in an automatic dishwasher.
